(19) United States
(12) Patent Application Publication
(10) Pub. No.: US 2008/0118252 A1
(43) Pub. Date: May 22, 2008

(54) Optical coupler with reduced pulse width distortion

(76) Inventors: Fun Kok Chow, Singapore (SG); Hock Tiong Kwa, Singapore (SG); Richard K. Klum, Singapore (SG)

Correspondence Address: Kathy Manke;Avago Technologies Limited, 4380 Ziegler Road, Fort Collins, CO, 80525, US

(21) Appl. No.: 11/602,892

(22) Filed: Nov. 20, 2006

(51) Int. Cl. H04B 10/06; H04B 10/00

(52) U.S. Cl. 398/202; 398/135; 398/115

(57) ABSTRACT

An optical coupler having an optical transmitter and an optical receiver are disclosed. The optical transmitter receives a logic signal to be transmitted to a circuit connected to the optical receiver and a photo emitter for generating a light signal having an intensity related to the states of the logic signal. The optical receiver includes a photodetector assembly, a hold circuit, a threshold generating circuit, and a signal generator. The photodetector assembly receives the light signal and generates a photo signal having an amplitude related to that of the light signal. The hold circuit stores a potential related to the maximum amplitude of the photo signal during a preceding time period. The threshold generating circuit generates a high threshold signal related to the stored potential. The signal generator generates an output logic signal that has first and second states that change state when the photo signal crosses the high threshold.

### BACKGROUND OF THE INVENTION

In many circuit arrangements, a logic signal must be transmitted between two circuits that must otherwise be electrically isolated from one another. For example, the transmitting circuit could utilize high internal voltages that would present a hazard to the receiving circuit or individuals in contact with that circuit. In the more general case, the isolating circuit must provide both voltage and noise isolation across an insulating barrier. Such isolation circuits are often referred to as “galvanic isolators”. One class of galvanic isolators is based on transforming the logic signal to a light signal that is then transmitted to an optical receiver in the receiving circuit that converts the optical signal back to an electrical signal. The transmitting and receiving circuits are typically on separate substrates and connected to separate power supplies.

The logic signal is typically transmitted to an optical signal by modulating the power to a light-emitting diode (LED). The modulated light signal is directed to a photodiode in the receiving circuit. The output of the photodiode is processed by a transimpedance amplifier that converts the current generated by the photodiode to a voltage signal that is then input to a circuit that detects the points at which the voltage signal crosses a predetermined threshold level. These crossing points are then used to reconstitute the logic signal at the receiving side, i.e., to generate a voltage signal that switches between two logic levels.

Ideally, the logic signals leaving the receiver should have the same pulse widths as the logic signals that entered into the transmitter so that the output signal matches the input signal to within a small delay. To meet this condition, transimpedance amplifiers having a very high frequency performance are required, which significantly increases the cost of the optical coupling system, even in systems in which the frequency of the logic signals is relatively low.

In the absence of such high frequency amplifiers, the pulse width of the signals leaving the receiver is typically greater than that of the logic signal entering the transmitter. To accommodate variations in LEDs in the receiver and degradation of the LEDs over time, a relatively low threshold is set in the receiving circuit. The transimpedance amplifier in the receiving circuit has finite rise and fall times that distort the signals. Since the threshold values are set below the midpoint of the voltage signal in the receiver, the threshold detector tends to switch too early on the rising edge of a pulse and too late on the falling edge of the pulse.

### SUMMARY OF THE INVENTION

The present invention includes an optical coupler having an optical transmitter and an optical receiver. The optical transmitter includes a driver that receives a logic signal having first and second states to be transmitted to a circuit connected to the optical receiver and a photo emitter for generating a light signal having an intensity related to the states in the logic signal. The optical receiver includes a photodetector assembly, a hold circuit, a threshold generating circuit, and a signal generator. The photodetector assembly receives a light signal characterized by an optical intensity and generates a photo signal having an amplitude related to the optical intensity. The hold circuit receives the photo signal and stores a potential related to the maximum amplitude of the photo signal during a preceding time period. The threshold generating circuit generates a high threshold signal related to the stored potential. The signal generator receives the photo signal and the high threshold signal and generates an output logic signal that has first and second states. The output logic signal changes from the first state to the second state when the photo signal changes from a potential greater than the high threshold to a potential less than the high threshold. The threshold generating circuit can also generate a low threshold signal, the signal generator receiving the low threshold signal and causing the logic signal to change from the second state to the first state when the photo signal changes from a potential less than the low threshold signal to a potential greater than the low threshold signal. The threshold generating circuit can also include a circuit that generates a minimum threshold value, the low threshold signal being set to the minimum threshold signal when the stored potential is less than a predetermined potential.

### BRIEF DESCRIPTION OF THE DRAWIMGS

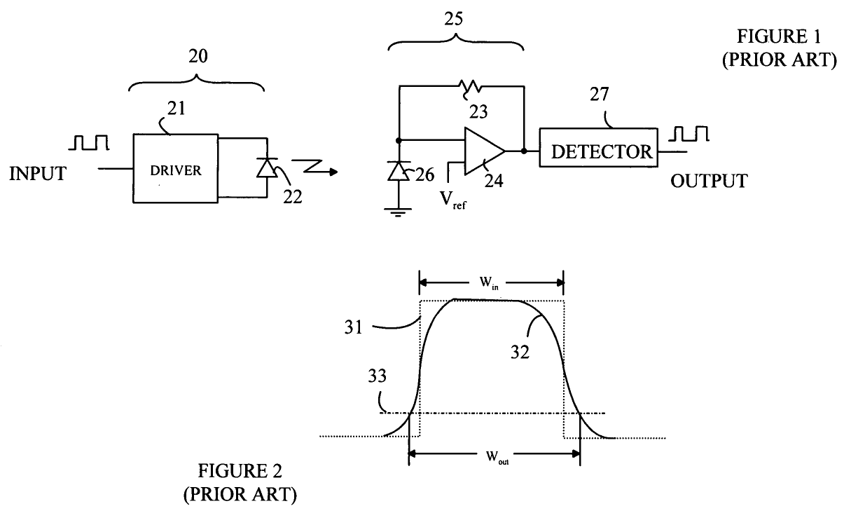

FIGS. 1 and 2 illustrate a typical prior art optical coupler and the output signals of the TIA in the receiving section.

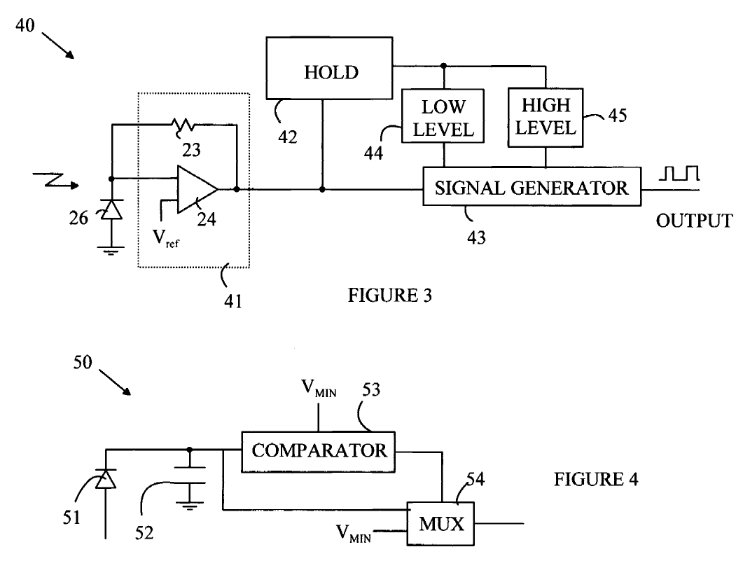

FIG. 3 is a schematic drawing of an optical receiver according to one embodiment of the present invention.

FIG. 4 is a schematic drawing of one embodiment of a hold circuit that can provide a minimum output voltage.

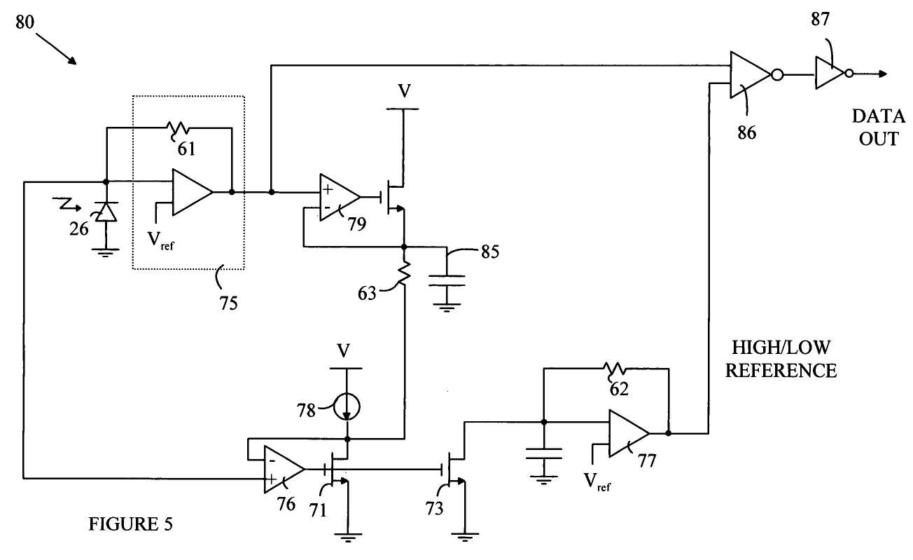

FIG. 5 is a schematic drawing of a portion of a receiver according to the present invention.

### DETAILED DESCRIPTION OF THE EMBODIMENTS OF THE INVENTION

The manner in which the present invention provides its advantages can be more easily understood with reference to FIGS. 1 and 2, which illustrate a typical prior art optical coupler and the output signals of the trans-impedance amplifier (TIA) in the receiving section. Referring to FIG. 1, an optical coupler typically has a transmitting section 20 and a receiving section 25. The transmitting section receives a logic signal that switches between two predetermined levels. The signal is applied to light emitter 22, which is typically an LED. The light from the LED is received by a photodiode 26 in the receiver. The current generated by photodiode 26 is converted to a voltage signal by a TIA consisting of opamp 24 and feedback resistor 23. The output of the TIA is converted back into a logic signal by detector 27, which has an output that switches between two predetermined levels when the input crosses a threshold voltage.

The threshold voltage is normally set relatively low to compensate for aging in the LED and variations in the photodiode and LED. The threshold level utilized by detector 27 is typically set once at the time the coupler is fabricated. Hence, the level must function adequately over the life of the device, and, in addition, fimction adequately over the manufacturing variations associated with the LED, photodiode, and alignment of the LED and photodiode within the coupler. Over the life of the optical coupler, the output of LED 22 will decrease significantly over time. Alignment errors also result in a decrease in the light signal detected by photodiode 26. Hence, the threshold is set at the lowest reasonable level.

The low threshold level, together with the finite frequency response of the TIA, lead to pulse width distortion. That is, a pulse of width Wᵢₙ, in the input signal is converted to a pulse of width Wₒᵤₜ in the receiver where Wₒᵤₜ is significantly different from Wᵢₙ. The manner in which this distortion is generated can be more easily understood with reference to FIG. 2. Consider the case in which the input to driver 21 is a square wave of duration Wᵢₙ as shown at 31. In general, amplifier 24 will have a finite frequency response. Hence, the output of amplifier 24 will have finite rise and fall times as shown 32. As a result, the output of amplifier 24 will cross threshold 33 early on the rising edge of the output pulse and late on the trailing edge. Hence, the duration of the logic signal generated by switching at the crossing points, Wₒᵤₜ is greater than that of the original input signal.

This problem can be overcome by using a TIA that has a significantly higher frequency response. However, the cost of utilizing a faster TIA is impractical for many applications.

In principle, this problem could be overcome by setting threshold 33 higher. For example, threshold 33 could be increased until the output pulse duration is the same as the input pulse duration. However, this would require calibrating each coupler separately, which would significantly increase the cost of the devices. In addition, any such calibration would only be valid for some period of time. In this regard, it should be noted that the decreasing light output over time from the LED is equivalent to raising the threshold value, and hence, the output pulse duration decreases over time until the device fails because the entire output pulse is below the threshold value.

The present invention overcomes this problem by continuously adjusting the threshold value during the operation of the device based on the observed signal strength from the TIA . Refer now to FIG. 3, which is a schematic drawing of an optical receiver according to one embodiment of the present invention. Receiver 40 includes a photodiode 26 connected to a TIA 41 that generates a signal that is proportional to the light intensity received by photodiode 26. The output of TIA 41 is processed by a signal generator 43 that has an output that switches between two logic levels. Signal generator 43 switches its output from the low level to the high level when the signal input to signal generator 43 crosses a low threshold level. Signal generator 43 switches its output from the high level to the low level when the signal input crosses a high threshold level. The low and high threshold levels are input to signal generator 43. The threshold levels are generated by level generators 44 and 45 that generate signals that are a preset function of the input level to the level generators. The input to each level generator is supplied by hold circuit 42 that captures the maximum potential generated by TIA 41 during a preceding time period. Hence, the threshold levels are continuously updated.

When the receiver is first powered up or the input to the hold circuit has been at a low level for an extended period of time, the voltage stored in the hold will not be sufficiently high to generate valid threshold levels. This problem is overcome by setting a minimum level for the output of hold circuit 42 that is sufficient to provide operative threshold levels when the receiver starts after an extended period during which no light signal is received. This level will assure that the device is always operative; although the initial low threshold will be less than optimum, and hence, some pulse width distortion could be present in the first pulse output from the receiver.

Refer now to FIG. 4, which is a schematic drawing of one embodiment of a hold circuit that can provide the minimum output voltage described above. The signal from the TIA is trapped on capacitor 52 by diode 51. A comparator 53 compares the voltage on capacitor 52 to a minimum voltage level, Vₘᵢₙ. Multiplexer 54 then selects either Vₘᵢₙ or the voltage on capacitor 52 to be output to the threshold generating circuits.

It should be noted that over time, the voltage on capacitor 52 would decrease due to leakage through the circuitry attached to that capacitor. If successive pulses from the TIA are of substantially the same height or greater than the previously stored voltage on capacitor 52 then the voltage on capacitor 52 will be updated to the maximum potential in the current pulse. If, however, the output of the TIA suddenly decreases by more than the voltage loss due to leakage, the new pulse will not update the value stored on capacitor 52. In general, this is of little practical concern, since the output of the TIA only decreases slowly over time because of the aging of the LED that generates the light source detected by photodiode 26.

The above-described embodiments depend on the threshold level generating circuits shown at 44 and 45. These circuits can be incorporated with the sample and hold function discussed above. Refer now to FIG. 5, which is a schematic drawing of a receiver according to one embodiment of the present invention. Receiver 80 utilizes a current copying circuit to copy the current through feedback resistor 61 in TIA 75. This current is then used to generate two reference threshold currents, one for the positive edge of each pulse and one for the negative edge. The threshold currents can be adjusted to any ratio as required by adjusting the ratio of the areas of the current mirror transistors 71 and 73, which will be denoted by M in the following discussion. Two gain boosting amplifiers 76 and 79 are used to copy the voltage between the nodes of TIA 75 to the nodes on either side of resistor 63. A small threshold current Iₜₕ is set by current source 78. This threshold current is used to set the initial current in mirror transistor 73 and sets the low reference threshold value. The initial current in mirror transistor 73 is M*Iₜₕ. The copied current plus Iₜₕ is mirrored in amplifier 77 by mirror transistor 73. If the resistance of resistor 62 is also set to the same value as resistor 63, the current through resistor 62 will be the same as that through photodiode 26.

The low threshold voltage provided by receiver 80 is equal to Iₜₕ*R*M, where R is the resistance of resistors 61-63 and M is the ratio of the areas of transistors 73 and 71. The high threshold is equal to the low threshold plus DV*M where DV is the difference in voltage across resistor 61 at the peak of the photocurrent through photodiode 26. Assume that at the start of a light pulse applied to photodiode 26, capacitor 85 is discharged. In this case, the current flowing into amplifier 76 is the current from current source 78, i.,e., Iₜₕ. As a result, a current having a magnitude of IₜₕM will flow through resistor 62, and the output of amplifier 77 will be Iₜₕ*R*M. This reference voltage is applied to the input of comparator 86. The other input to comparator 86 is the output of TIA 75. Hence, when the output reaches the low reference voltage, the data out signal generated by inverter 87 will switch to the high state. As the output of TIA 75 increases, the voltage is stored on capacitor 85 and the current into amplifier 76 will increase until the maximum output from TIA 75 is reached. This output voltage is DV. This additional voltage gives rise to an additional current equal to DV divided by the resistance of resistor 63, which in this embodiment is also equal to R. Hence, the current in resistor 62 will increase by DV*M/R, and the voltage across resistor 62 will increase to the high threshold value, Iₜₕ*R*M+DV*M. This voltage is copied to the input of comparator 86 and becomes the new threshold value. When the output of TIA 75 falls below this value, the output data signal will switch to the low state.

The capacitance of capacitor 85 is chosen such that the capacitor will discharge during the low data state, and hence, each cycle will begin with a low threshold value that is set by the current from current source 78. Hence, the low threshold is set at a fixed value while the high threshold is set at a value that depends on the peak height of the photocurrent from photodiode 26.

Various modifications to the present invention will become apparent to those skilled in the art from the foregoing description and accompanying drawings. Accordingly, the present invention is to be limited solely by the scope of the following claims.

What is claimed is:

1. An optical receiver comprising:
a photodetector assembly that receives a light signal characterized by an optical intensity and generates a photo signal having an amplitude related to said optical intensity;
a hold circuit that receives said photo signal and stores a potential related to the maximum amplitude of said photo signal during a preceding time period;
a threshold generating circuit that generates a high threshold signal related to said stored potential; and
a signal generator that receives said photo signal and said high threshold signal and generates an output logic signal that has first and second states, said output logic signal changing from said first state to said second state when said photo signal changes from a potential greater than said high threshold to a potential less than said high threshold.

2. The optical receiver of claim 1 wherein said photodetector assembly comprises a photodiode and a transimpedance amplifier for converting a current flowing in said photodiode to said photo signal;

3. The optical receiver of claim 1 wherein said threshold generating circuit also generates a low threshold signal, said signal generator receiving said low threshold signal and causing said logic signal to change from said second state to said first state when said photo signal changes from a potential less than said low threshold signal to a potential greater than said low threshold signal.

4. The optical receiver of claim 1 further comprising a circuit for generating a minimum threshold value, said low threshold signal being set to said minimum threshold value when said stored potential is less than a predetermined potential.

5. The optical receiver of claim 1 wherein said threshold generator comprises first and second transistors and wherein said high threshold level depends on the ratio of the areas of said first and second transistors.

6. The optical receiver of claim 4 wherein said circuit for generating said minimum threshold value comprises a constant current source that generates a predetermined current.

7. An optical coupler comprising an optical transmitter and an optical receiver, said optical transmitter comprising a driver that receives a logic signal having first and second states to be transmitted to a circuit connected to said optical receiver and a photo emitter for generating a light signal having an intensity related to the states in said logic signal,
said optical receiver comprising:
a photodetector assembly that receives a light signal characterized by an optical intensity and generates a photo signal having an amplitude related to said optical intensity;
a circuit that receives said photo signal and stores a potential related to the maximum amplitude of said photo signal during a preceding time period;
a threshold generating circuit that generates a high threshold signal related to said stored potential; and
a signal generator that receives said photo signal and said high threshold signal and generates an output logic signal that has first and second states, said output logic signal changing from said first state to said second state when said photo signal changes from a potential greater than said high threshold to a potential less than said high threshold.

8. The optical coupler of claim 7 wherein said photodetector assembly comprises a photodiode and a transimpedance amplifier for converting a current flowing in said photodiode to said photo signal;

9. The optical coupler of claim 7 wherein said threshold generating circuit also generates a low threshold signal related to said stored potential, said signal generator receiving said low threshold signal and causing said logic signal to change from said second state to said first state when said photo signal changes from a potential less than said low threshold signal to a potential greater than said low threshold signal.

10. The optical coupler of claim 7 further comprising a circuit for generating a minimum threshold value, said low threshold signal being set to said minimum threshold signal when said stored potential is less than a predetermined potential.

11. A method for generating a logic signal from an optical signal, said method comprising:
converting said optical signal to an electrical signal having an amplitude related to the intensity of said optical signal;
storing a signal related to the maximum potential of said electrical signal over a preceding time period;
generating a high threshold value related to said stored signal;
generating a logic signal that has first and second states from said electrical signal, said logic signal changing from said first state to said second state when said electrical signal changes from a potential greater than said high threshold to a potential less than said high threshold; and
outputting said logic signal.

12. The method of claim 11 further comprising generating a low threshold value related to said stored signal; and
causing said logic signal to change from said second state to said first state when said electrical signal changes from a potential less than said low threshold value to a potential greater than said low threshold value.

13. The method of claim 11 further comprising generating a minimum threshold value, said low threshold value being set to said minimum threshold signal when said stored potential has a value less than a predetermined value.
